(19) United States
(12) Patent Application Publication
(10) Pub. No.: US 2006/0101963 A1
(43) Pub. Date: May 18, 2006

(54) Shaping apparatus

(76) Inventor: Daniel Adkins, Corbin, KY (US)

Correspondence Address: KING & SCHICKLI, PLLC, 247 NORTH BROADWAY, LEXINGTON, KY, 40507, US

(21) Appl. No.: 11/273,357

(22) Filed: Nov. 14, 2005

Related U.S. Application Data
(60) Provisional application No. 60/629,288, filed on Nov. 18, 2004.

(51) Int. Cl. B26F 3/00

(52) U.S. Cl. 83/177

(57) ABSTRACT

A shaping apparatus for cutting, joining, or otherwise affecting a workpiece. The apparatus includes a template having a surface defining a path, a shaper, and a compressing member holding a portion of the shaper substantially against the template. The shaper is in communication with a motive force capable of driving the shaper along at least a portion of the path. The shaper becomes activated to affect the workpiece without direct contact of the shaper with the workpiece.

This application claims the benefit of U.S. Provisional Application No. 60/629,288 filed Nov. 18, 2004, the disclosure of which is incorporated herein by reference.

### TECHNICAL FIELD

The present invention relates generally to a shaping apparatus or tool useful in cutting or joining material. More specifically, it relates to a high speed, fully or semi-automated shaping apparatus which may have at least one template for guiding a cutter. In other aspects, the cutter may be replaced with a joining or other apparatus.

### BACKGROUND OF THE INVENTION

Fully or semi-automated cutting or joining machines are used in many manufacturing processes. From large assembly lines to small machine shops, many organizations employ these machines to increase productivity and repeatability when forming a workpiece. Some of the more popular semi-automated cutting or joining machines utilize computer numerically controlled (CNC) systems for manipulating the cutting or joining tool. For example, a user may program a computer controlled robotic arm to perform an operation utilizing a cutting or joining tool.

Problematically, these robotic arms require a relatively large amount of operating space for movement of the arm. This space requirement often prevents the simultaneous use of multiple robotic arms, thus limiting the speed at which a workpiece can be cut or joined.

Additionally, the cost associated with the initial purchase, operation, and maintenance of a robotic controlled arm is burdensome, ultimately increasing the cost to produce the desired part. Moreover, when a user desires to change the cutting or joining process or pattern, the complexity of programming the robotic arm often leads to extensive machine downtime, further decreasing productivity and increasing costs.

Accordingly, the material cutting and joining arts have need for a low-cost, high speed, fully or semi-automated shaping apparatus having a mechanism for guiding a cutter, joiner, or other apparatus. Furthermore, the need exists for a shaping apparatus that allows for quick and easy modification to the pattern being shaped, as well as a machine that can operate in a confined area.

### SUMMARY OF THE INVENTION

In accordance with one aspect of the present invention as described herein, a high speed, fully or semi-automated shaping apparatus having at least one template for guiding a cutter, joiner, or other apparatus is disclosed. The shaping apparatus includes a shaper, a template having a surface defining a path, and a compressing member for holding a portion of the shaper substantially against the surface of the template. The shaper is in communication with a motive force capable of driving the shaper along at least a portion of the path of the template. The shaper becomes activated to affect the workpiece with or without direct contact of the shaper with the workpiece.

In one embodiment, the shaper is a cutter in communication with a motive force, such as a motor, and the cutter cuts a workpiece without direct contact of the cutter with the workpiece. The cutter may take the form of a water jet cutter with a tube having an outlet with a nozzle. The tube may pass through a bushing such that the tube remains substantially stationary with respect to the bushing during movement. The compressing member may comprise a spring that forces the tube against the surface of the template. The surface defining the path may be an exterior surface of the template. The surface may also be a surface defined by a fixed or an adjustable aperture. When the motor drives the cutter, the tube follows a path defined by the template. When the cutter becomes activated, water ejects from the nozzle of the cutter and cuts the workpiece. One may also replace or use the cutter with a joiner or other apparatus for joining or otherwise affecting the workpiece.

The following drawings pertain to one possible embodiment of this invention, and are merely designed to illustrate one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention.

In the drawings:

FIG. 1 is a side view of a shaping apparatus in the form of a water-jet cutter forming one possible embodiment of the present invention;

FIG. 2 is a partially exploded view of the apparatus of FIG. 1;

FIG. 3 is a bottom view of the apparatus of FIG. 1;

FIG. 4a is a diagram showing one possible embodiment of an iris of the apparatus of FIG. 1;

FIG. 4b is a diagram showing repositioning of the iris of FIG. 4a;

FIG. 4c is a side view of a shaping apparatus in the form of a water-jet cutter having a plurality of templates, each with an aperture of a different dimension forming one possible embodiment of the present invention;

FIG. 4d is a top view of one possible template of the apparatus of FIG. 4c;

FIG. 4e is a top view of one possible template of the apparatus of FIG. 4c;

FIG. 4f is a top view of one possible template for one embodiment of the present invention;

FIG. 5 is a schematic diagram showing one possible water delivery system for the apparatus of FIG. 1;

FIGS. 6a-6c are side views of various embodiments of templates of the apparatus of FIG. 1; and

FIG. 7 is a bottom view of a template used with a plurality of cutters and/or joiners forming one possible embodiment of the present invention.

### DETAILED DESCRIPTION OF THE INVENTION

As mentioned above, one aspect of the present invention includes a high speed, fully or semi-automated shaping apparatus which may have at least one template for guiding a shaper, such as a cutter, joiner or other apparatus. The shaper resides in communication with a motive force capable of driving the shaper along at least a portion of a path defined by a surface of the template. When activated, the shaper cuts, joins, or otherwise affects a workpiece. The motive force may drive the shaper while the shaper simultaneously cuts, joins or otherwise affects the workpiece. Alternatively, the shaper may remain substantially stationary during its cutting, joining, or otherwise affecting the workpiece.

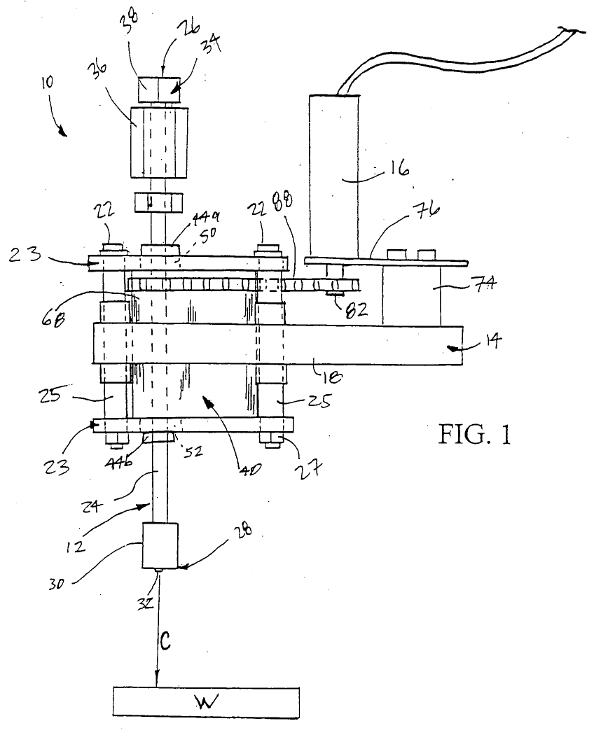

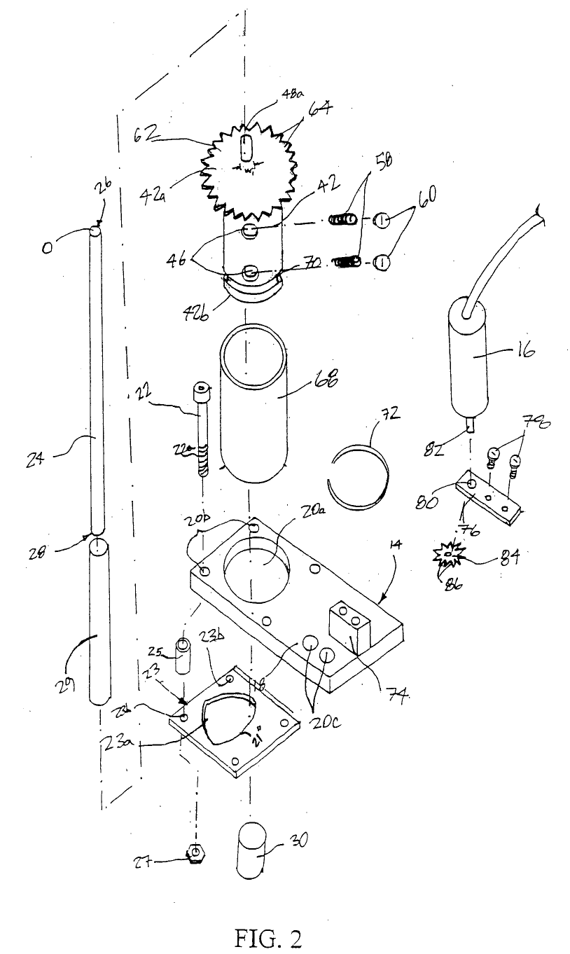

Reference is now made to FIGS. 1 and 2 illustrating a shaping apparatus 10 forming one embodiment of the present invention. As shown, the apparatus 10 comprises a shaper, such as a cutter 12, a base 14, and a motive device, such as a motor 16 in mechanical communication with the cutter 12.

In one embodiment, the base 14 includes a substantially rectangular plate 18 having a plurality of apertures 20a-20c. The apertures 20a-20c may consist of various sized openings adapted to receive components of the apparatus 10. As shown in FIG. 2, the aperture 20a receives the cutter 12, while the apertures 20b receive an adjustable fastener, such as a stud 22, that enables easy removal and replacement of the template, as discussed later in further detail. The base 14 also includes apertures 20c for mounting the apparatus 10 to an auxiliary structure (not shown). For example, an individual may attach or use the apparatus 10 with the inventor's Water Jet Cutting Machine described in pending U.S. patent application Ser. No. 10/304,636 filed Nov. 26, 2002, and published May 27, 2004, as U.S. Patent App. Pub. No. US 2004/0099111, the entirety of which is herein incorporated by reference.

As shown in FIGS. 1-3, the cutter 12 may include a high pressure water jet comprising a conduit or tube 24 having an inlet end 26 and an outlet end 28 positioned in a housing 40. A nozzle 30 having an orifice 32 attaches to the outlet end 28 of the tube 24. The nozzle 30 may semi-permanently attach to the tube 24 via a threaded screw fitting or welding. The orifice 32 may have any diameter suitable for the desired cutting properties, and may be either fixed in diameter or adjustable. As representatively shown in FIG. 1, when the cutter 12 becomes activated, water exits the orifice 32 in a direction of the action arrow C towards the surface of a workpiece W. Thus, the cutter 12 cuts the workpiece W without direct contact of the cutter with the workpiece. A skilled artisan will appreciate that the nozzle 30 may comprise any configuration of nozzle or nozzle assembly. For instance, it may include a multi-piece assembly including a nozzle nut retaining an orifice consisting of a jewel mounted in an insert.

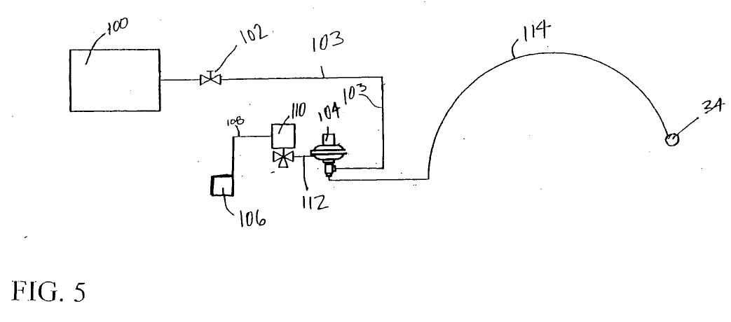

The tube 24 may include a coupling 34 positioned towards the inlet end 26. The coupling 34 may comprise a solenoid valve 36 and a fastener 38 for placing the inlet end 26 of the tube 24 in fluid communication with a fluid supply (not shown). A computer system or any hardware/software electronic controller (not shown) in electrical communication with the solenoid valve 36 may control the flow of water into the tube 24. This controller may also control the motor 16, such that the activation of the solenoid valve 36 and the motor 16 may work in concert. Alternatively, as shown in FIG. 5, a conventional high pressure intensifier 100 delivers water, preferably in a range of 30,000 to 55,000 psi, through a manual shut off valve 102. The high pressure water flows through separate lines 103 to a standard air activated high pressure ON/OFF water valve 104. In one embodiment, high pressure air supplied from a remote source 106 operates the valve 104. The air passes through an air inlet line 108 to an electrically operated solenoid switch 110, through the switch, when open, to a valve air inlet line 112 and, finally to the valve 104. Upon operation of the solenoid switch 110 to open the valve 104, high pressure water is supplied along a water line 114 to the coupling 34.

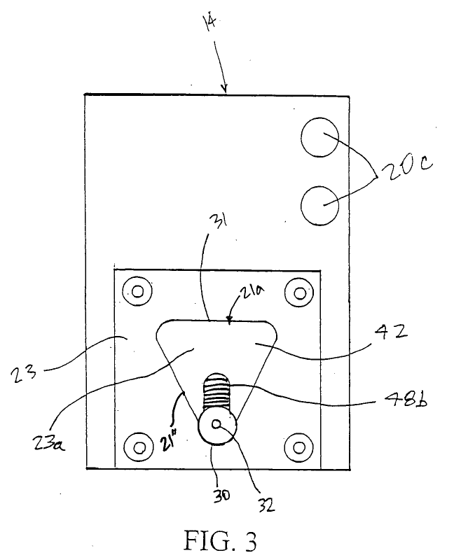

As previously mentioned, the tube 24 may reside in the housing 40. In one embodiment, the housing 40 comprises a substantially enclosed cylinder 42, defining a chamber, having at least one opening 46 positioned in the side of the cylinder 42. The cylinder 42 also includes an aperture, such as a slot 48a, extending from the center of a top surface 42a, as well as a corresponding slot 48b (FIG. 3) positioned similarly in the bottom surface 42b of the cylinder 42. The slots 48a, 48b may have a width W₁ substantially equal to or larger than an outer diameter 0 of the tube 24, such that the slots 48a,48b may receive a portion of the tube 24. In one embodiment, the tube 24 passes through a tube bushing 29 and substantially through the slots 48a, 48b and the cylinder 42. In operation of the apparatus 10, the tube bushing 29 rotates, while the tube 24 remains substantially stationary with respect to the tube bushing 29. This helps prevent twisting of the line 114 providing water to the coupling 34 of the tube 24.

After insertion through the cylinder 42, a first bearing 50 may attach to the tube 24 adjacent to the top surface 42a of the cylinder 42, while a second bearing 52 may attach adjacent to the bottom surface 42b. However, the number of bearings and positioning of the bearings on the tube 24 may correspond to the number of templates 23 being used. The bearings 50 and 52 may engage an inner surface 21″ of the aperture 23a of the at least one template 23. The tube 24 may also include a collar 44a and/or 44b positioned adjacent to the bearing to minimize axial movement of the tube 24 through the cylinder 42.

With reference to FIG. 2, the cylinder 42 may have at least one compressing member, such as a spring 58 inserted through the opening 46. A retainer 60, such as a threaded plug, may become inserted into the cylinder 42 to hold the spring 58 against the tube 24. In this configuration, the spring 58 forces the tube 24 against the inner surface of the cylinder 42, while forcing the bearing 50 and/or 52 against the inner surface 21″ of the aperture 23a of the template 23. The cylinder 42 may include any number or size of springs 58 or other device to balance the force of the tube 24 or bearings 50, 52 against the inner surface 21″ of the template 23 and/or cylinder 42. During operation of the apparatus 10, the bearings 50,52 follow the outline of the aperture 23a of the template 23. One will appreciate that the tube 24 may directly contact the inner surface 21″ of the aperture 23a, thereby obviating the need for bearings 50, 52.

The cylinder 42 may also have a sprocket 62 positioned near the top surface 42a. The sprocket 62 may semi-permanently attach to the cylinder 42 via welding or friction fit, or the sprocket 62 may be formed with the cylinder 42 as one piece. The sprocket 62 may have any number or configuration of teeth 64 adapted to engage a driven member, such as a chain 88, as discussed below.

As shown, the housing 40 also includes a bushing 68 adapted to receive the cylinder 42. In one embodiment, the cylinder 42 passes substantially through the bushing 68 such that a portion of the bottom surface of the sprocket 62 contacts a top surface of the bushing 68, while the bottom surface 42b of the cylinder extends beyond the boundary of the bushing 68. Alternatively, the cylinder 42 may include a projection or lip (not shown) positioned under the sprocket 62 near the top surface 42a, such that the lip contacts the top surface of the busing 68. The cylinder 42 may also include a recess 70 positioned toward the bottom surface of the cylinder 42 for receiving a retainer, such as a lock ring 72. The lock ring 72 helps prevent axial movement of the cylinder 42 within the bushing 68.

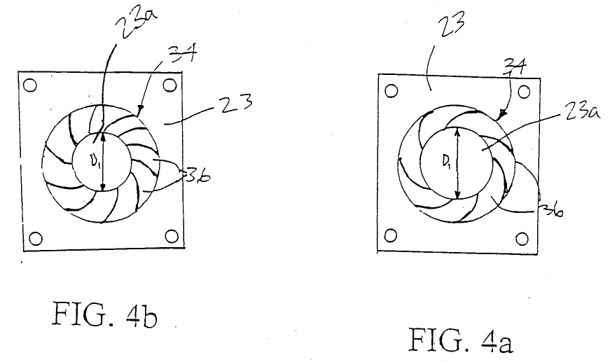

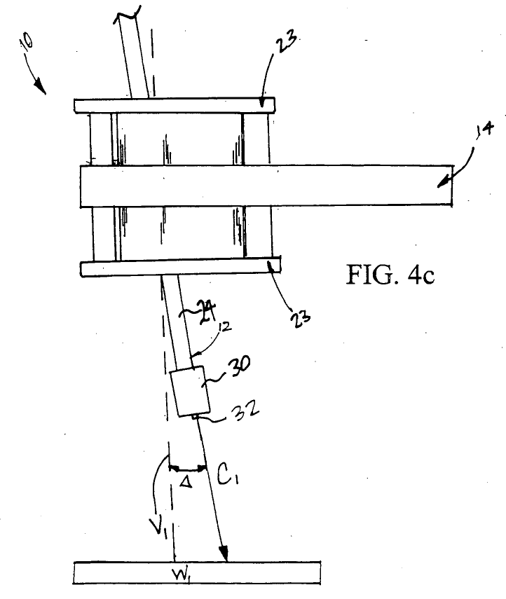

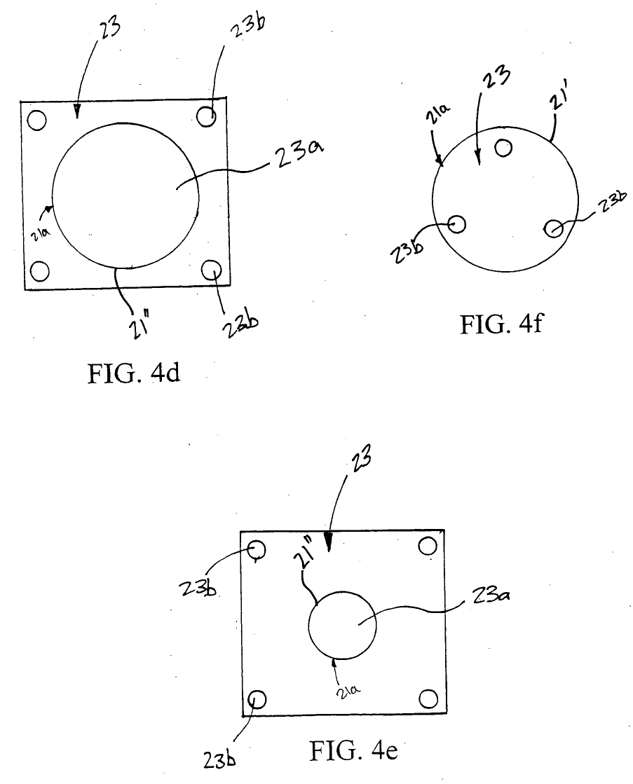

As previously mentioned, the aperture 20a of the base 14 may receive the housing 40 and tube 24 forming the cutter 12. In one embodiment, at least one template 23 captures the cutter 12 on the base 14. The template 23 includes a surface defining a path 21a. As shown in FIG. 4f, the surface defining the path 21a may be an exterior surface 21′ of the template 23. The surface may also be a surface 21″ defined by an aperture 23a (FIGS. 2,3, and 4d-4e). The template 23 includes additional apertures 23b for receiving at least a portion of an adjustable fastener, such as the stud 22. This adjustable fastener enables easy removal and replacement of the template when changing the pattern being shaped. A spacer 25 may become positioned on the stud 22 for laterally offsetting the template 23 from the base 14. A user may vary the offset of the template 23 by modifying the length of the spacer 25. This enables a user to adapt the apparatus 10 to meet their shaping requirements. The stud 22 may include a threaded portion 22a adapted for receiving a corresponding nut 27, thereby enabling connection of the template 23 to the base 14.

The surfaces 21′, 21″, and the aperture 23a of the template 23 may be any size or shape for directing the tube 24 and nozzle 30 of the cutter 12 in any desired direction or pattern. For instance, the shape may embody a substantially triangular or quadrilateral shape for making automobile parts, such as visors or headliners. When using one or more templates 23 with substantially identical fixed apertures 23a, one will appreciate that the nozzle 30 of the cutter 12 is positioned substantially perpendicular to the workpiece W.

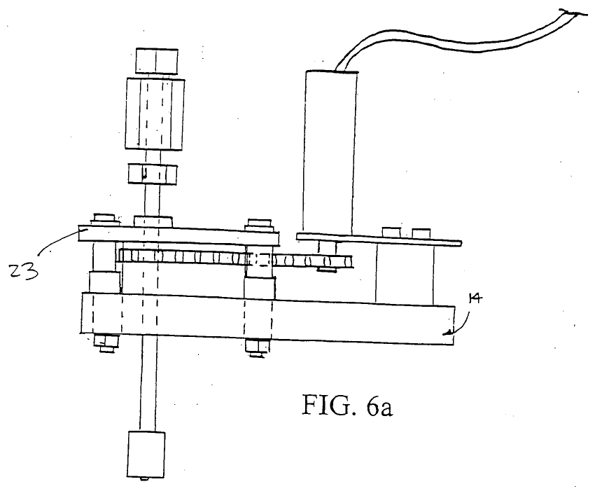

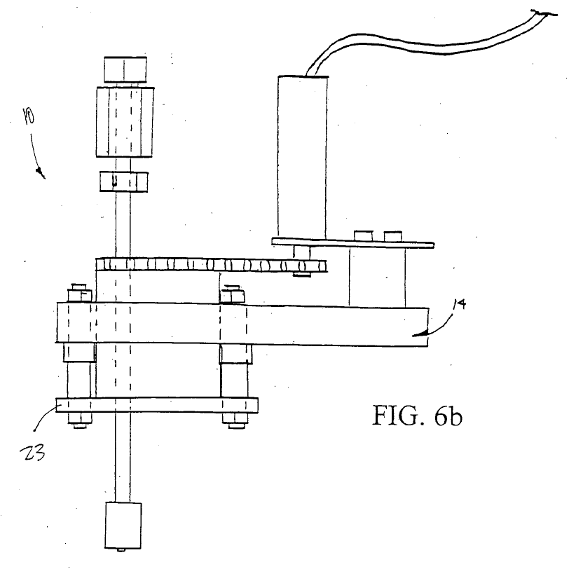

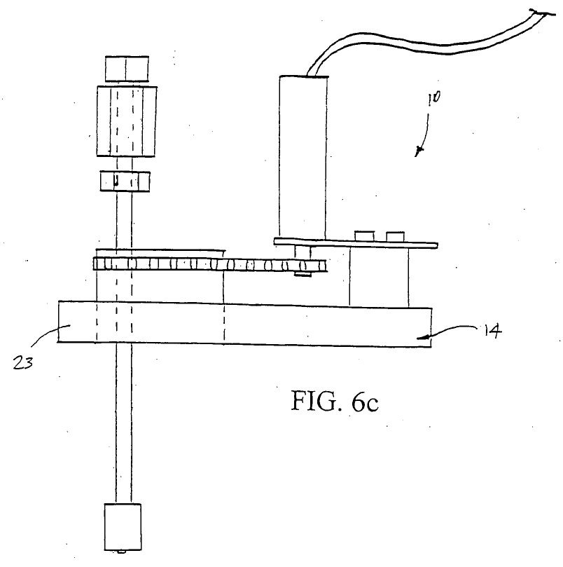

In one embodiment, shown in FIGS. 4a and 4b, an iris 34 replaces the fixed diameter aperture 23a of the template 23. The iris 34 may include an electrically or mechanically controlled diaphragm or a plurality of adjustable plates 36 enabling a user to modify the diameter D₁ of the iris 34, and the path of the cutter 12 during movement. As shown in FIGS. 6a and 6b, the apparatus 10 may include one template 23 positioned above or below the base 14. Alternatively, the apparatus 10 may include a plurality of templates 23 for guiding the tube 24 during operation (FIG. 1). Also, the aperture 23a or template 23 may be incorporated in the base 14, thereby obviating the need for a separate template 23 (FIG. 6c). Thus, the apparatus 10 may include any number or configuration of templates 23. A skilled artisan will appreciate that the apparatus 10 may be used without a template, thus cutting substantially circular patterns when the cutter 12 becomes activated.

When using more than one template, a skilled artisan will appreciate the desire for axial alignment of the templates 23. The use of the studs 22 in conjunction with the base 14 encourages alignment of the templates 23. Additionally, a skilled artisan will appreciate that varying the dimensions of template 23 and the size of the inner surface 21″ may impact the forces of the tube 24 or bearings 50, 52 engaging the inner surface 21″.

In one embodiment, shown in FIGS. 4c-4e, the apparatus 10 may be used to form slanted, angled, or tapered cuts, such as when forming bevels or cones. To accomplish this, a user may employ a single template 23 having an angled surface 21′, 21″ or multiple templates 23 having surfaces 21′, 21″ with different dimensions, such as fixed apertures 23a of different dimensions. Since the tube 24 or bearings 50 and/or 52 become forced against the inner surface 21″ of the apertures 23a of the templates 23 (as discussed above), the tube 24 and nozzle 30 become offset an angle A from the substantially vertical line V₁ (FIG. 4c). In other words, the nozzle 30 of the cutter 12 is positioned at an angle other than 90° with respect to the workpiece. Upon activation of the cutter 12, such as the high pressure water jet, water exits the orifice 32 in the direction of the action arrow C₁, thereby forming a slanted or angled cut in a workpiece W₁. A skilled artisan will appreciate that one may use the iris 34, as previously discussed, for varying the dimensions of the apertures 23a of one or more templates 23 and modifying the angle Δ of the tube 24 and nozzle 30.

With reference to FIGS. 1 and 2, the base 14 also includes a support 74 positioned adjacent to the cutter 12. The support 74 may include a mount 76 fixedly attached thereto for receiving the motor 16. The mount 76 may attach to the support via mechanical fasteners, such as bolts 78, welding, or otherwise. An aperture 80 positioned in the mount may receive a drive shaft 82 of the motor 16. In this configuration, the motor 16 is axially offset from the cutter 12. However, the motor 16 may attach to the mount 76 in any manner to allow movement of the drive shaft 82. A sprocket 84 having a plurality of teeth 86 may say semi-permanently attach to the drive shaft 82 via welding or otherwise for positioning the sprocket 84 substantially planar with the sprocket 62 of the cutter 12. An endless chain 88 may engage the teeth 64 of the sprocket 62, as well as the teeth 86 of the sprocket 84, thereby coupling the sprockets 62, 84 together.

In this configuration, a skilled artisan will appreciate that energizing the motor 16 causes rotation of the drive shaft 82 and rotation of the sprocket 84, which in turn causes rotation of the chain 88 and cylinder 42 of the cutter 12. As previously discussed, the arrangement of springs 58 with the cylinder 42 causes the tube 24 or bearings 50,52 to engage and follow the inner surface 21″ of the aperture 23a of the template 23. Since the tube 24 or bearings 50, 52 follow the path 21a of the template 23, when simultaneously driving the cutter 12 with the motor 16 along the entire path 21a and activating the cutter 12, a user may quickly and accurately cut a piece of material in the same pattern as the path 21a (such as a substantially triangular pattern when using the template shown in FIG. 3). However, the motor 16 may drive the shaper along only a portion of the path 21a while the cutter 12 is simultaneously activated. Alternatively, the motor 16 may drive the shaper to a specific point along the path 21a before the cutter 12 is activated, thus the cutter 12 may remain substantially stationary during activation and cut at only a single location in the workpiece. One will appreciate that the path 21a of the template 23 may be any shape and that a user may change the shape of the material cut by simply replacing the current template with a template having a different path.

The components of the apparatus 10 may be fabricated from any well-known types of materials, with aluminum or stainless steel being preferred for at least the cutter 12, base 14, and template 23. These materials have good corrosion and strength properties, as well as provide the apparatus 10 with a high-quality appearance.

The foregoing descriptions of various embodiments of the invention are provided for purposes of illustration, and are not intended to be exhaustive or limiting. Modifications or variations are also possible in light of the above teachings. For example, while described in one embodiment as a water jet cutting apparatus, the cutting apparatus may utilize a laser, torch, plasma cutter, electric discharge machining (EDM), or any other type of cutter. During activation, these cutters eject laser light, plasma, or any other substance for cutting the workpiece. Additionally, the shaper may be substituted with a joiner such as a welder, an adhesive dispenser, or other joiner. During activation, these joiners eject electricity, glue, or any other substance for joining or preparing a workpiece to be joined. Accordingly, the water representatively shown exiting the orifice 32 in a direction of the action arrows C and C₁ towards the surface of the workpieces W and W₁ may be replaced with laser light, plasma, adhesive, or any other substance.

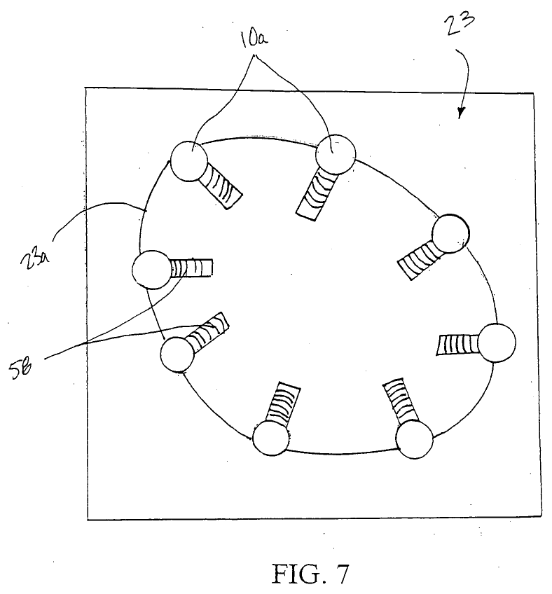

The shaper, such as the cutter, joiner, or other, may affect the workpiece without direct contact of the shaper with the workpiece. Alternatively, the shaper may directly contact the workpiece, if desired. Moreover, a single apparatus may include any combination of the cutters and joiners. As generally shown in FIG. 7, a plurality of joiners or cutters 10A (or any combination therein) may become positioned in a housing, driven by a single motor. While one embodiment shows the motor 16 driving the sprockets 62 and 84 via a chain, a skilled artisan will appreciate that any type of drive mechanism can be used. Additionally, the cutter or joiner may be directly driven by a motor or other device, thereby obviating the need for a chain or sprockets. As previously mentioned, the apparatus 10 may become mounted to any device or structure. For instance, the apparatus 10 may connect to the end of a conventional robotic arm or other conventional machining tools. The embodiments described above were chosen to provide the best application to thereby enable one of ordinary skill in the art to utilize the disclosed inventions in various embodiments and with various modifications as are suited to the particular use contemplated. All such modifications and variations are within the scope of the invention.

1. A shaping apparatus for cutting, joining, or otherwise affecting a workpiece, comprising:
a template having a surface defining a path;
a shaper in communication with a motive force capable of driving the shaper along at least a portion of the path, the shaper becomes activated to affect the workpiece without direct contact of the shaper with the workpiece; and
a compressing member holding a portion of the shaper substantially against the surface of the template.

2. The shaping apparatus of claim 1, wherein the shaper is a cutter, the motive force is a motor, and movement of the cutter cuts the workpiece without direct contact of the cutter with the workpiece.

3. The shaping apparatus of claim 2, wherein the cutter is positioned substantially perpendicular to the workpiece.

4. The shaping apparatus of claim 2, wherein the cutter is positioned at an angle other than 90° with respect to the workpiece.

5. The shaping apparatus of claim 2, wherein the cutter is a water jet cutter having a tube with a nozzle at one end of the tube, and the compressing member is a spring that holds a portion of the tube against the surface of the template during movement of the cutter.

6. The shaping apparatus of claim 2, wherein the cutter is a water jet cutter having a tube passing through a bushing such that the tube remains substantially stationary with respect to the bushing during movement of the cutter.

7. The shaping apparatus of claim 1, wherein the template includes a fixed aperture and the surface defining the path is a surface defined by the aperture.

8. The shaping apparatus of claim 1, wherein the surface defining the path is an exterior surface of the template.

9. A shaping apparatus, intended for cutting, joining, or otherwise affecting a workpiece, comprising:
a base having at least one aperture for receiving a housing;
a first template laterally offset from the base, the first template having a surface defining a path;
a shaper, at least partially positioned within the housing, in communication with a motive force capable of driving the shaper along at least a portion of the path, the shaper becomes activated to affect the workpiece without direct contact of the shaper with the workpiece;
a compressing member holding a portion of the shaper substantially against the surface of the template.

10. The shaping apparatus of claim 9, wherein the template attaches to the base via at least one adjustable fastener that enables easy removal and replacement of the first template.

11. The shaping apparatus of claim 9, wherein the template includes a fixed aperture and the surface defining the path is a surface defined by the aperture.

12. The shaping apparatus of claim 9, wherein the surface defining the path is an exterior surface of the template.

13. The shaping apparatus of claim 9, wherein the shaper is a water jet cutter having a tube passing substantially through the housing and the first template, and the cutter cuts the workpiece without direct contact of the cutter with the workpiece.

14. The shaping apparatus of claim 13, wherein the tube passes through a bushing such that the tube remains substantially stationary with respect to the bushing during movement of the shaper.

15. The shaping apparatus of claim 14, wherein the housing comprises a substantially enclosed cylinder and the bushing passes through first and second apertures of the cylinder.

16. The shaping apparatus of claim 15, wherein the first and second apertures of the cylinder comprise slots extending from the center of a top and bottom surface of the cylinder.

17. The shaping apparatus of claim 16, wherein the first and second slots are substantially aligned and have a width greater than or equal to the diameter of the tube.

18. The shaping apparatus of claim 17, wherein the compressing member comprises a spring that becomes inserted through an opening on the cylinder.

19. The shaping apparatus of claim 18, wherein the housing includes a bushing adapted to receive the cylinder.

20. The shaping apparatus of claim 19, further comprising a sprocket positioned near the top surface of the cylinder and the sprocket engages a member driven by the motive force.

21. The shaping apparatus of claim 20, wherein the motive force is a motor axially offset from the cutter, such that the cutter is indirectly moved by the motor.

22. The shaping apparatus of claim 9, further comprising a second template laterally offset from the base.

23. The shaping apparatus of claim 22, wherein the first and second templates attach to the base via at least one adjustable fastener that enables easy removal and replacement of the first and second templates.

24. The shaping apparatus of claim 22, wherein the first and second templates each have a substantially identical aperture.

25. The shaping apparatus of claim 22, wherein the first and second templates have different size apertures.

26. The shaping apparatus of claim 22, wherein one of the first and second templates has an adjustable aperture.

27. The shaping apparatus of claim 22, wherein the first and second templates are substantially axially aligned.

28. The shaping apparatus of claim 22, wherein the aperture of one of the first and second templates is an iris that enables a user to modify the diameter of the aperture and the path of the cutter.

29. The shaping apparatus of claim 22, wherein the first template is positioned above the base and the second template is positioned below the base.

30. The shaping apparatus of claim 29, wherein the shaper is a water jet cutter having a tube passing substantially through the housing and the first and second templates.

31. The shaping apparatus of claim 29, wherein the shaper is a water jet cutter having a tube passing substantially through a bushing, the housing, and the first and second templates, such that the tube remains substantially stationary with respect to the bushing during movement of the cutter.

32. A shaping apparatus, intended for cutting, joining, or otherwise affecting a workpiece, comprising:
a template having a surface defining a path;
a plurality of compressing members holding a plurality of shapers substantially against the surface of the template;
a plurality of shapers in communication with a motive force capable of driving the shapers along at least a portion of the path, the shapers become activated to affect the workpiece without direct contact of the shaper with the workpiece; and
a plurality of compressing members holding the shapers substantially against the surface of the template.

33. The shaping apparatus of claim 32, wherein the template includes a fixed aperture and the surface defining the path is a surface defined by the aperture.

34. The shaping apparatus of claim 33, wherein the plurality of shapers are cutters and simultaneous movement and activation of each cutter cuts a portion of the workpiece without direct contact of the cutters with the workpiece.

35. A water jet cutting apparatus, comprising:
a base having at least one aperture for receiving a housing;
a template having a surface defining a path, the template is laterally offset from the base and attaches to the base via at least one adjustable fastener that enables easy removal and replacement of the template;
a cutter in communication with a motive force capable of driving the cutter along at least a portion of the path, the cutter has a conduit at least partially positioned in a bushing, wherein the bushing is at least partially positioned in the housing;
the conduit includes a nozzle having an orifice positioned at the outlet end of the conduit, outside the housing;
a compressing member holding a portion of the cutter substantially against the surface of the template;
wherein activation of the cutter ejects water from the orifice to cut the workpiece.
